(19) United States
(12) Patent Application Publication
(10) Pub. No.: US 2024/0314650 A1
(43) Pub. Date: Sep. 19, 2024

(54) METHOD, BASE STATION, CORE NETWORK NODE, USER EQUIPMENT, NEIGHBOUR CELL RELATION TABLE

(71) Applicant: NEC Corporation, Minato-ku, Tokyo (JP)

(72) Inventors: Maxime GRAU, Guildford (GB); Neeraj GUPTA, London (GB)

(73) Assignee: NEC Corporation, Minato-ku, Tokyo (JP)

(21) Appl. No.: 18/579,640

(22) PCT Filed: Jun. 30, 2022
(86) PCT No.: PCT/JP2022/026297

§ 371 Date: Jan. 16, 2024

(30) Foreign Application Priority Data
Jul. 21, 2021 (GB) 2110490.6

(51) Int. Cl. H04W 36/00; H04W 36/08; H04W 84/18

(52) U.S. Cl. CPC H04W 36/0061; H04W 36/08; H04W 84/18

(57) ABSTRACT

A system is disclosed in which a base station receives information indicating a cell category associated with a neighbour cell and stores the cell category information in a neighbour cell relation table. The base station May receive the cell category information from a UE, from an Access and Mobility Function, or from a base station operating the neighbour cell. The cell category information may indicate, amongst others, that the neighbour cell is a cell of a non-terrestrial network, a small cell, or an energy saving cell.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to neighbour cell relation management in the so-called ‘5G’ (or ‘Next Generation’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, NPL 1.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 2 and NPL 3 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).

### NG-RAN Node: Either a gNB or an Ng-eNB.

3GPP is also working on specifying an integrated satellite and terrestrial network infrastructure in the context of 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS-all operating quasi-stationary at an altitude typically between 8 and 50 km.

NPL 4 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). NPL 5 provides further details about NTN.

### Non-Terrestrial Networks are Expected to:

help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

### NTN Access Typically Features the Following Elements (Amongst Others):

NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

### 3GPP Intends to Support Three Types of NTN Beams or Cells:

Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals.

Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’).

### CITATION LIST

### Non Patent Literature

NPL 1: ‘NGMN 5G White Paper’ V1.0, Next Generation Mobile Networks (NGMN) Alliance, <https://www.ngmn.org/5g-white-paper.html>
NPL 2: 3GPP TS 38.300 V16.6.0
NPL 3: 3GPP TS 37.340 V16.6.0
NPL 4: 3GPP TR 38.811 V15.4.0
NPL 5: 3GPP TR 38.821 V16.1.0
NPL 6: 3GPP TS 25.484 V16.0.0

### SUMMARY OF INVENTION

### Technical Problem

The inventors have realised that the intermittent availability of NTN cells from the point of view of (conventional) neighbour cells may require frequent changes to the neighbour lists maintained at neighbour base stations. Specifically, the following changes may occur frequently (due to the movement of the satellite/UAS platform):
From a terrestrial cell perspective, LEO and MEO NTN cells appear and disappear every few minutes to hours; and
From an earth-moving NTN cell perspective, the terrestrial neighbour cells change as the NTN cell moves around the Earth.

The inventors have also realised that energy saving cells that switch on and off depending on cell load may cause a similar issue. Accordingly, the term ‘intermittent cell’ may be applied to a variety of cells that keep on appearing and disappearing.

Since Operation and Maintenance (OAM) functionality is not designed to update neighbour cells so often, base stations have a so-called Autonomous Neighbour Relation (ANR) for managing their list of neighbour cells. The ANR functionality is described in NPL 2 and NPL 6 which describe the way a Neighbour Cell Relation (NCR) Table is used and kept up-to-date with the list of neighbours and certain special relations (e.g. handover not allowed).

Although there are various procedures for setting up neighbour cells (e.g. during Xn setup, using the SON configuration transfer procedure, or using UE visited cell history information) these procedures do not take into account the specific issues relating to intermittent cells and currently there is no mechanism to convey appropriate assistance information for effective management of neighbour relations in case of non-terrestrial cells and/or the like.

Conventional ANR functionality relies heavily on information acquired and provided by the UEs. However, in case of intermittent cells, the associated entries in the NRT are removed by the base station when the cells are no longer available as neighbours and the relevant information need to be acquired and added again whenever these cells become neighbour cells again. This approach is clearly inefficient and wasteful of resources (and battery power of the UE) since the same information need to be acquired and provided repeatedly whenever an intermittent cell is added as a new neighbour cell.

Accordingly, the present disclosure seeks to provide methods and associated apparatus that address or at least alleviate (at least some of) the above described issues.

### Solution to Problem

Although for efficiency of understanding for those of skill in the art, the disclosure will be described in detail in the context of a 3GPP system (5G networks including NTN), the principles of the disclosure can be applied to other systems as well.

In one aspect, the disclosure provides a method performed by a base station, the method comprising: receiving information relating to a cell category associated with a neighbour cell; and updating neighbour cell information based on the received information.

In one aspect, the disclosure provides a method performed by an Access and Mobility Function (AMF), the method comprising: obtaining information relating to a cell category associated with a cell; and providing said information to a base station operating a neighbour cell.

In one aspect, the disclosure provides a method performed by a user equipment (UE), the method comprising: obtaining information relating to a cell category associated with a neighbour cell; and providing said information to a base station.

In one aspect, the disclosure provides a base station comprising: means for receiving information relating to a cell category associated with a neighbour cell; and means for updating neighbour cell information based on the received information.

In one aspect, the disclosure provides an Access and Mobility Function (AMF) comprising: means for obtaining information relating to a cell category associated with a cell; and means for providing said information to a base station operating a neighbour cell.

In one aspect, the disclosure provides a user equipment (UE) comprising: means for obtaining information relating to a cell category associated with a neighbour cell; and means for providing said information to a base station.

In another aspect, the disclosure provides a base station comprising a processor, a transceiver, and a memory storing instructions; wherein the controller is configured to: receive information relating to a cell category associated with a neighbour cell; and update neighbour cell information based on the received information.

In another aspect, the disclosure provides an Access and Mobility Function (AMF) comprising a processor, a transceiver, and a memory storing instructions; wherein the controller is configured to: obtain information relating to a cell category associated with a cell; and provide the obtained information to a base station operating a neighbour cell.

In another aspect, the disclosure provides a user equipment (UE) comprising a processor, a transceiver, and a memory storing instructions; wherein the controller is configured to: obtain information relating to a cell category associated with a neighbour cell; and provide the obtained information to a base station.

The disclosure also provides a neighbour cell relation table configured to store at least one of: information identifying a cell category associated with at least one cell; ephemeris information for at least one cell; and cell timing information for at least one cell.

Aspects of the disclosure extend to corresponding systems and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device forming part of the system shown in FIG. 1;

FIG. 3 is a schematic block diagram of an access network node (e.g. base station) or an NTN node (e.g. satellite/UAS platform) forming part of the system shown in FIG. 1;

FIG. 4 is a schematic block diagram of a core network node (e.g. AMF) forming part of the system shown in FIG. 1;

FIG. 5 is a signalling (timing) diagram illustrating some exemplary ways in which embodiments of the present disclosure may be performed in the system shown in FIG. 1;

FIG. 6 is a signalling (timing) diagram illustrating some exemplary ways in which embodiments of the present disclosure may be performed in the system shown in FIG. 1;

FIG. 7 is a signalling (timing) diagram illustrating some exemplary ways in which embodiments of the present disclosure may be performed in the system shown in FIG. 1;

FIG. 8 is a signalling (timing) diagram illustrating some exemplary ways in which embodiments of the present disclosure may be performed in the system shown in FIG. 1; and

FIG. 9 illustrates schematically an exemplary neighbour cell relation table in accordance with the present disclosure.

### DESCRIPTION OF EMBODIMENTS

### Overview

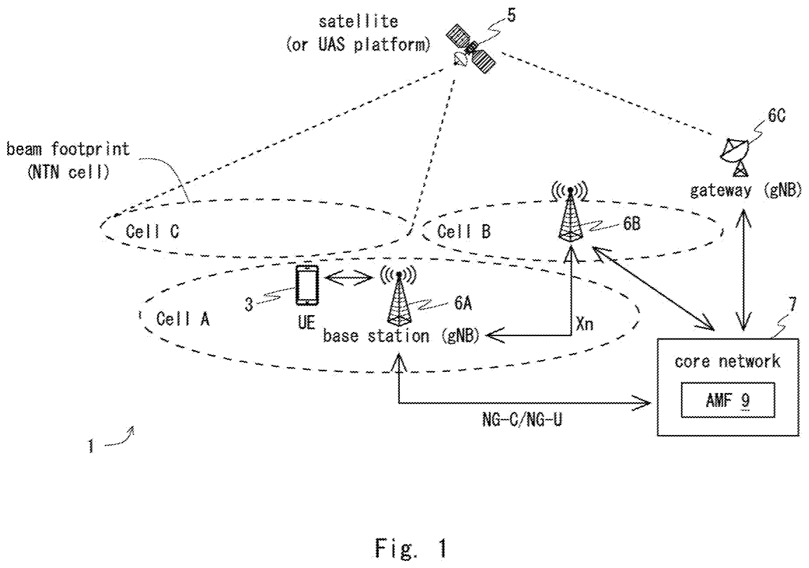

FIG. 1 illustrates schematically a mobile (cellular or wireless) telecommunication system 1 to which embodiments of the disclosure may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA and/or 5G RAT. As those skilled in the art will appreciate, whilst one mobile device (UE) 3, one satellite 5, and three base stations 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6C) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although some of these connections are omitted in FIG. 1, neighbouring base stations 6 are connected to each other via an appropriate base station to base station interface (such as the so-called ‘X2’ interface, ‘Xn’ interface and/or the like). The base stations 6 are also connected to the nodes of the core network via an appropriate interface (such as the so-called ‘S1’, ‘NG-C’, ‘NG-U’ interface, and/or the like).

The data network or core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) 9 is responsible for handling connection and mobility management tasks for the mobile devices 3. The core network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID.

In the system 1 shown in FIG. 1, two base stations 6A and 6B operate conventional (terrestrial) cells, denoted ‘Cell A’ and ‘Cell B’, respectively. In this example, Cell A and Cell B comprise NR (or 5G) cells although they may also comprise 4G cells (e.g. operated by an ng-eNB). When one of the cells is configured as an energy (power) saving cell (e.g. Cell B) it may be switched on and off depending on the load of that cell. In addition, a third base station 6C operates an NTN cell (‘Cell C’) via an associated NTN node 5.

In the following, the term ‘intermittent cell’ will be used to refer to a cell which is not a permanent neighbour of another cell. For example, for Cell A, an energy saving cell (Cell B) or an NTN cell (Cell C) may appear and disappear periodically. Similarly, from the NTN cell's point of view, any terrestrial neighbour cell (e.g. Cell A) may change at regular intervals as the beam footprint of the NTN node 5 moves along the surface of the Earth.

Beneficially, in this system the access network nodes 6 (base stations/NTN gateways) are configured to acquire and store appropriate cell category information and/or any additional cell information for managing their neighbour relation tables. For a particular neighbour cell, the associated neighbour relation information (e.g. in the NCR table) may indicate one or more of the following cell category (or type): small cell; energy saving cell; Ultra-Reliable Low-Latency Communication (URLLC) cell; terrestrial cell; non-terrestrial cell.

In case of energy saving cells, associated Cell Timing information may also be stored in the NRT. Similarly, for NTN cells, ephemeris data may be stored from which the access network nodes 6 can derive the time when a given NTN cell is available as a neighbour cell. In case of a non-terrestrial (NTN) cells, the appropriate sub-category may also be stored, for example, GEO/NGEO/LEO/MEO/HEO/HAP cell; quasi-earth-fixed cell; earth-moving cell, etc.

The access network nodes 6 may be configured to obtain the cell category information and any associated timing information (or ephemeris information) either from the UE 3 (using an appropriate measurement reporting configuration), from the base station 6 operating the cell in question, or from the AMF 9 (which may obtain such information from each base station in advance).

This information may be stored in the NCR table of the access network nodes 6 and used for planning/prioritising handovers and cell reselection (e.g. to avoid intermittent cells when appropriate). The information may also be used to activate/deactivate certain neighbour cells based on their associated timing info (without removing the corresponding neighbour relation data).

Beneficially, the above methods allow the base station 6 to obtain (and save in the NCR table) information identifying at least the category of its neighbour cells and optionally other assistance information (including but not limited to cell timing information and/or ephemeris data). The neighbour cell category allows the base station to prioritise terrestrial cells for handover over NTN cells. If available, the timing information (for neighbouring NTN or energy saving cells) allows the base station to plan handovers accordingly and to broadcast appropriate cell reselection assistance information to UEs in its cell. Using the obtained information the base station can avoid having to continuously remove and add intermittent neighbour cells, and it also reduces the load and battery usage of UEs (as they do not need to listen to system information of neighbouring cells and report previously known information).

### User Equipment (UE)

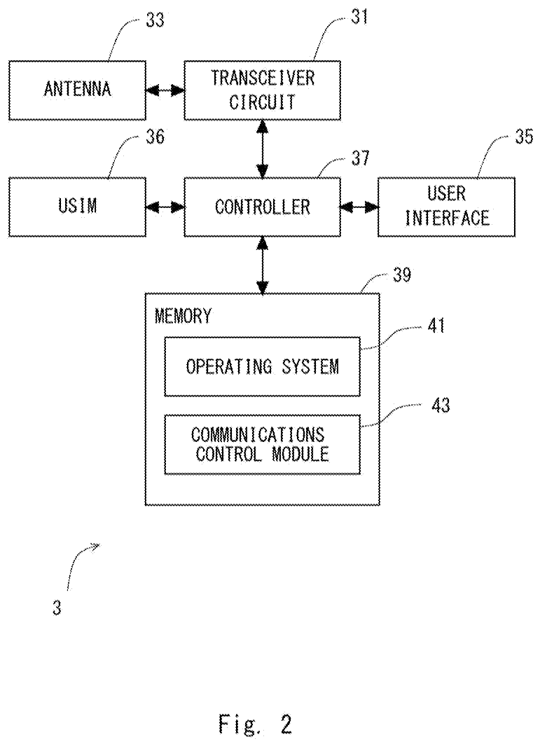

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35 and a Universal Subscriber Identity Module (USIM) 36) which may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, and a communications control module 43.

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling (e.g. RRC signalling) related to signal/cell measurements and associated reporting, and neighbour cell relations management (by the serving base station).

### Access Network Node (Base Station/Gateway) and NTN Node

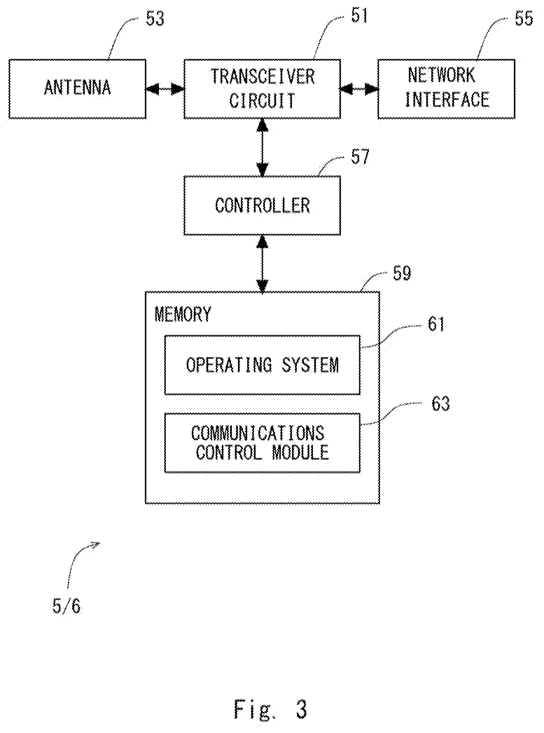

FIG. 3 is a block diagram illustrating the main components of an access network node 6 (such as the base station (gNB) or the gateway) shown in FIG. 1. FIG. 3 is also applicable to the NTN node 5 (satellite or UAS platform). As shown, the access network node 6/NTN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. Signals may be transmitted to and received from the UE(s) 3 either directly and/or via one or more NTN node(s) 5, as appropriate. The network interface 55 typically includes an appropriate base station-base station interface (such as X2/Xn) and an appropriate base station-core network interface (such as S1/NG-C/NG-U), although these are optional in case of the NTN node 5. A controller 57 controls the operation of the access network node 6/NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the access network node 6/NTN node 5 and other nodes, such as the UE 3, other NTN nodes 5/base stations 6, and core network nodes (e.g. the AMF 9). The signalling may comprise control signalling related to signal/cell measurements by the UE 3 and associated reporting, and neighbour cell relations management.

### Core Network Node (AMF)

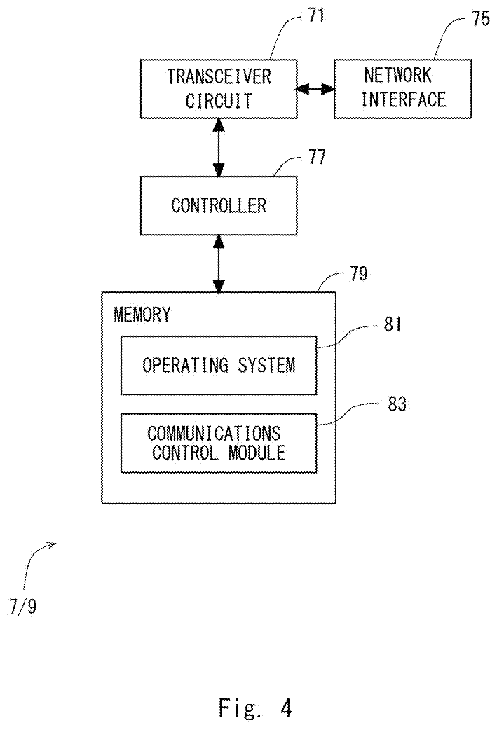

FIG. 4 is a block diagram illustrating the main components of a core network node shown in FIG. 1, such as the AMF 9. As shown, the core network node includes a transceiver circuit 71 which is operable to transmit signals to and to receive signals from other network nodes (either directly or indirectly) via a network interface 75. The network interface 75 typically includes an appropriate core network-base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the core network node and the UE 3, the access network nodes, and other core network nodes. The signalling may comprise control signalling related to signal/cell measurements by the UE 3 and associated reporting, and neighbour cell relations management.

### DETAILED DESCRIPTION

The following is a description of some exemplary procedures (Solutions 1 to 4) performed by the nodes of the system shown in FIG. 1, for acquiring cell category information and/or additional information relevant to a neighbour cell or cells.

For example, the associated cell category may be provided using a 1-bit field (or a flag) indicating whether the cell is an NTN cell or not. In this case, the field (or flag) may be set to a first value (e.g. ‘1’) when the cell is an NTN cell and set to a different value (e.g. ‘0’) otherwise. However, the cell category information may also specify further details about the cell such as whether the cell is a GEO, LEO, MEO, quasi-earth-fixed, or earth-moving cell, and any other cell categories if appropriate (e.g. small cells, URLLC cells, energy saving cells, etc.). The cell category information may be provided using one or more appropriate information elements (IEs).

Ephemeris information may also be provided for NTN cells (with the cell category indication or separately). When applicable, e.g. in case of NTN/energy saving cells, appropriate cell timing information may be provided such as information indicating when a particular cell will start/stop serving or a remaining serving time indication (although this information may also be derived from the ephemeris information, if available).

The following information elements are common to all solutions, and they may be carried in RRC signalling (Solution 1) or in S1AP/NGAP/XnAP signalling (Solutions 2 to 4). For the sake of simplicity, a single CellCategory-Info IE (which may include other IEs such as Category, Timing, and Ephemeris IEs) will be used as an example. However, it will be appreciated that any other suitable information element (or a combination of information elements) may be used.

Solution 1—Getting the Information from the UE

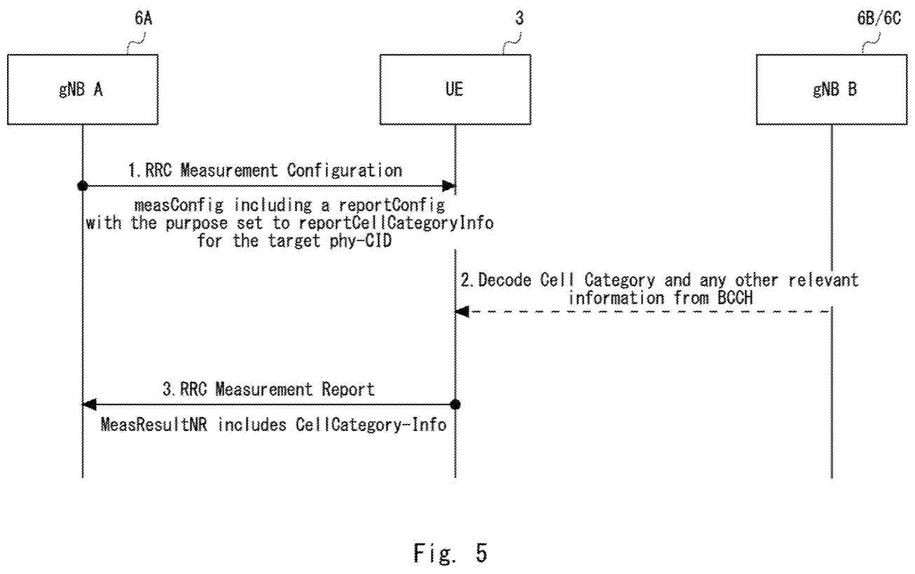

FIG. 5 is signalling (timing) diagram illustrating an exemplary way in which the base station requests the UE 3 to report the cell category information for a new neighbour cell. In this case, the base station 6A serving the UE 3 (in Cell A of FIG. 1) configures the UE 3 to acquire the relevant information from system information broadcast in the given (neighbour) cell.

Specifically, as generally illustrated in step 1, the base station 6A generates (using its communications control module 63) and transmits to the UE 3 a message for configuring the UE 3 to perform measurements of a (new) neighbour cell, or cells, and to report cell category information for the neighbour cell(s). In this example, the base station 6A uses an ‘RRC Measurement Configuration’ message and includes in this message an appropriate information element (e.g. a ‘reportConfig’ IE) that includes the relevant measurement parameters. The purpose of this request is to configure the UE 3 to report cell category information for a neighbour and this purpose may be indicated using an appropriate value (e.g. reportCellCategoryInfo purpose) in the reportConfig 1E. Step 1 may be preceded by the UE 3 reporting the physical cell identity (PCI) or the Cell Global ID (CGI) of a new neighbour cell (e.g. Cell B or Cell C which is not yet known to the base station 6A at this point). The message by the base station 6A (or the reportConfig 1E) may also include the PCI or CGI of the cell for which the information is requested, although this information may be omitted if there is no ambiguity regarding the target cell.

In step 2, using its communications control module 43, the UE 3 obtains the requested information from the neighbour cell, e.g. by decoding the cell category information and any other relevant information from system information being broadcast in the neighbour cell (via the Broadcast Control Channel). Thus, in the example shown in FIG. 1, the UE 3 determines that Cell C is an NTN cell, based on the information broadcast in that cell. If the UE 3 is requested to report the cell category for Cell B (which is not an NTN cell), the UE 3 may determine, based on system information in that cell, that Cell B is a conventional cell, a small cell, or an energy saving cell, as appropriate.

Once the information has been successfully acquired, and when any other applicable reporting conditions are met, the UE 3 generates (using its communications control module 43) an appropriate signalling message including the cell category information relating to the neighbour cell(s) being reported (e.g. in a CellCategory-Info IE and/or the like). As generally shown in step 3, the UE 3 transmits the message that includes the cell category information (for example an RRC Measurement Results message) to the base station 6A that requested this information.

For example, the MeasResultNR IE may be adapted to include appropriate cell category information (e.g. a cellCategory-Info IE and/or the like):

| | |
|---|---|
| MeasResultListNR ::= | SEQUENCE (SIZE (1..maxCellReport)) OF |

MeasResultNR

| MeasResultNR ::= | SEQUENCE { | |
|---|---|---|
| physCellId | PhysCellId | OPTIONAL, |
| measResult | SEQUENCE { | |
| cellResults | SEQUENCE{ | |
| resultsSSB-Cell | MeasQuantityResults | OPTIONAL, |
| resultsCSI-RS-Cell | MeasQuantityResults | OPTIONAL |

},

| rsIndexResults | SEQUENCE{ | |
|---|---|---|
| resultsSSB-Indexes | ResultsPerSSB-IndexList | OPTIONAL, |
| resultsCSI-RS-Indexes | ResultsPerCSI-RS-IndexList | OPTIONAL |

}

| | | |
|---|---|---|
| cellCategory-Info | CellCategory-Info | OPTIONAL, |

),
...

Alternatively, a new MeasResultNR-CellInfo/MeasResultNR-rel17 and/or any suitable (new or existing) information element may be used to convey the relevant cell category information (cellCategory-Info IE).

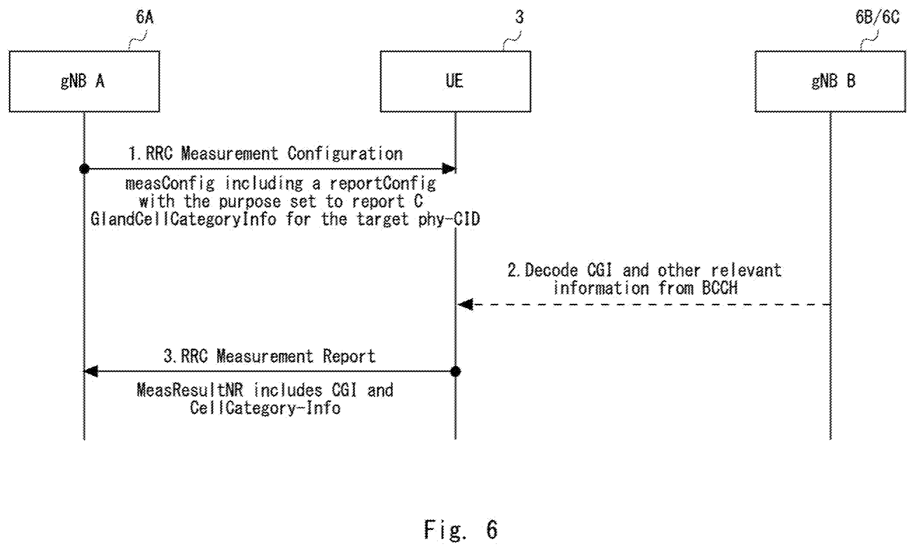

FIG. 6 is signalling (timing) diagram illustrating another way in which the base station 6A may request the UE 3 to report the cell category information for the new neighbour cell. In this example, it is assumed that the serving base station 6A has no knowledge (not even Cell Global ID) of the neighbour cell. The base station 6A requests the UE 3 to report the cell category information together with the associated CGI, which reduces the amount of RRC signalling and system information scanning for the UE 3 (since the CGI reporting and cell category information reporting procedures are combined).

The steps of FIG. 6 are essentially the same as the corresponding steps of FIG. 5, with the following differences. In step 1, the purpose is set to an appropriate value (e.g. reportCGIandCellCategoryInfo) indicating that the base station 6A is requesting the UE 3 to report both the CGI and the cell category information for a neighbour cell. In step 2 (which may comprise more than one steps), the UE 3 acquires the CGI and the cell category information for a neighbour cell (and any additional information identifying a sub-category etc.). The UE's report in step 3 includes both the CGI and the cell category information for the neighbour cell.

Although not shown in FIG. 5 and FIG. 6, the UE 3 may also obtain the related ephemeris information from the satellite operating Cell C (e.g. from associated system information) and provide this information to the serving base station 6 (in the ‘MeasResultNR’ IE or in any other suitable IE). Similarly, cell timing information may be obtained and reported with respect to Cell B (if available, assuming that Cell B is an energy saving cell and/or the like that does not operate continuously). The ephemeris/cell timing information may also be included in an appropriate field of the MeasResultNR IE (or MeasResultNR-CellInfo IE/MeasResultNR-rel17 IE).

Solution 2—Getting the Information from the Target Cell Via the AMF

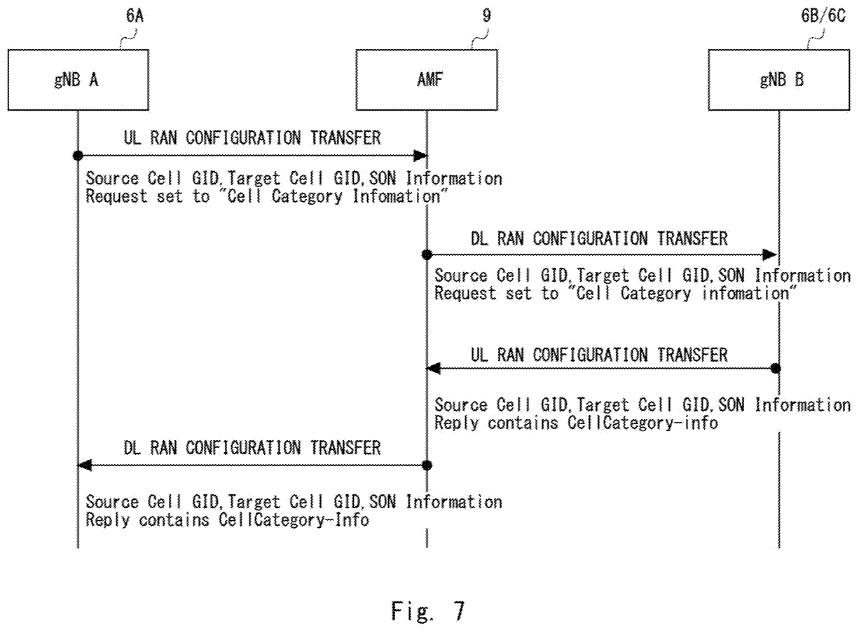

FIG. 7 is signalling (timing) diagram illustrating an exemplary way in which the base station 6A obtains the relevant cell category information for the new neighbour cell from the neighbour base station 6B/6C (via the AMF 9).

In this case, an appropriate Self-Organising Network (SON) Information Request procedure is used where the type of information being requested is set to a value indicating ‘Cell Category Information’.

In more detail, one of the base stations (in this case base station 6A) can initiate the procedure by generating and transmitting an appropriately formatted ‘UL RAN Configuration Transfer’ message towards the base station operating the neighbour cell. In step 1, the base station 6A transmits the message to the AMF 9 and addresses it to the neighbour cell for which information is requested, using its CGI. In step 2, the AMF 9 generates and transmits an appropriately formatted ‘DL RAN Configuration Transfer’ message to the base station operating the neighbour cell identified by the CGI (for example, base station 6C. operating Cell C).

The reply (step 3, UL RAN Configuration Transfer message) from the neighbour base station 6C includes the requested cell category information for Cell C (i.e. information indicating that Cell C is an NTN cell). As in the previous examples, the cell category information (and any additional relevant information) may be provided using the CellCategory-Info IE. In step 4, the AMF 9 forwards the cell category information (and any additional information) to the requesting base station 6A using an appropriately formatted DL RAN Configuration Transfer message.

A benefit associated with this approach is that the UE 3 only needs to acquire and report the CGI of the new neighbour cell and the rest of the information transfer is handled via the network nodes.

Solution 3—Getting the Information Directly from the AMF

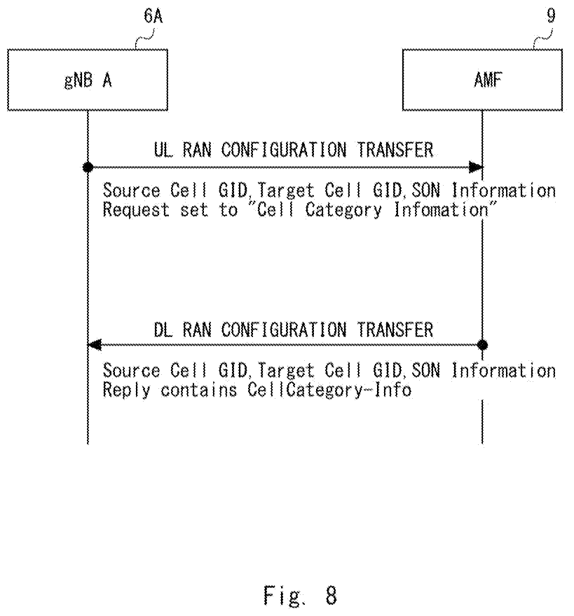

FIG. 8 is signalling (timing) diagram illustrating an exemplary way in which the base station 6A obtains the relevant cell category information for the new neighbour cell from the AMF 9.

This procedure is similar to Solution 2 (it is effectively the same from the requesting base station's point of view) but in this case the AMF 9 already holds the information and it does not need to query the target base station 6B/6C. The AMF 9 may be configured to acquire this information from each base station 6 during setting up or updating a connection with that base station 6 (e.g. during NG setup or RAN Configuration update). In this case, the signalling messages for setting up or updating a connection may be adapted to include the relevant cell category (e.g. using the CellCategory-Info IE or similar).

The AMF 9 may also be configured to acquire the cell category information from other sources, e.g. the OAM or another AMF that already has this information.

### Solution 4—Getting the Information Via the Xn Interface

A base station 6 may obtain the relevant cell category information for a new neighbour cell from the neighbour base station operating that cell, using the base station-base station interface (e.g. Xn) between them. In this case, there is no need to involve the core network/AMF 9.

For example, the relevant cell category information (e.g. CellCategory-Info IE and/or the like) may be included in a message for setting up the connection between the base stations. For example, the cell category information may be included, as part of the served cells information during Xn interface setup, in an appropriately formatted ‘XnSetupRequest’ message:

| | |
|---|---|
| XnSetupRequest ::= | SEQUENCE { |

| | | |
|---|---|---|
| protocolIEs | ProtocolIE-Container | {{ XnSetupRequest-IEs}}, |

...
}

| | |
|---|---|
| XnSetupRequest-IEs | XNAP-PROTOCOL-IES ::= { |

| { ID id-GlobalNG-RAN-node-ID | | CRITICALITY | reject |
|---|---|---|---|
| TYPE | GlobalNG-RANNode-ID | PRESENCE | mandatory}\| |
| { ID id-TAISupport-list | | CRITICALITY | reject |
| TYPE | TAISupport-List | PRESENCE | optional }\| |
| { ID id-AMF-Pool-Information | | CRITICALITY | reject |
| TYPE | AMF-Pool-Information | PRESENCE | mandatory}\| |

| | | |
|---|---|---|
| { ID id-List-of-served-cells-NR | CRITICALITY | reject |

| | | |
|---|---|---|
| TYPE | ServedCells-NR | PRESENCE |

optional }|

| | | |
|---|---|---|
| { ID id-List-of-served-cells-E-UTRA | CRITICALITY | reject |

| | | |
|---|---|---|
| TYPE | ServedCells-E-UTRA | PRESENCE |

optional },|
...
}

The ‘XnSetupResponse’ message may also be adapted to include the same (or similar) information elements.

### NCR Table Optimisations

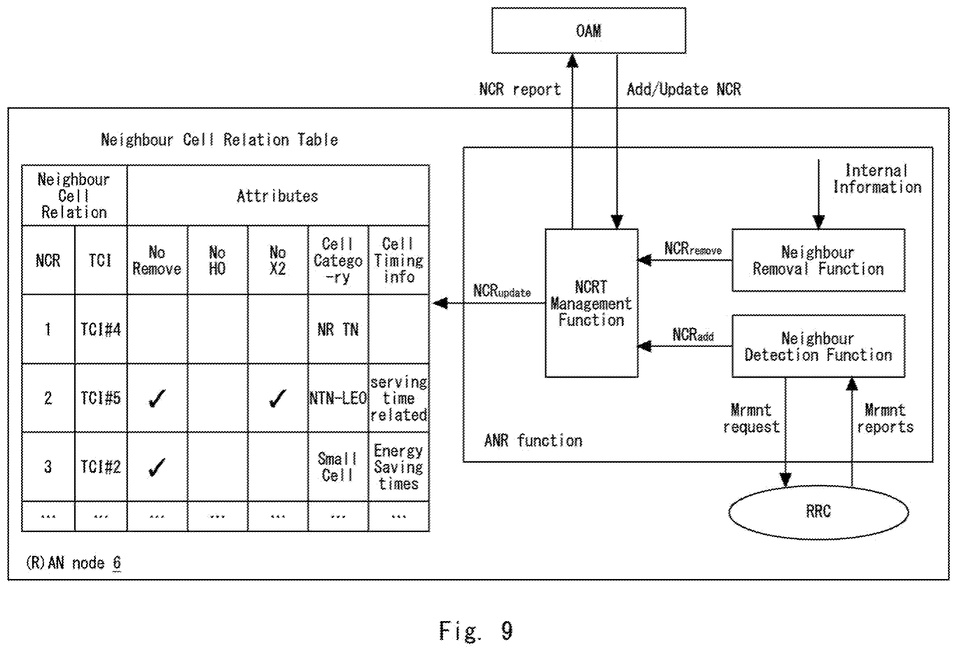

The obtained information (cell category and any additional information) may be stored in the NCR table of the base station 6 (RAN node). FIG. 9 illustrates schematically an exemplary neighbour cell relation table that has been adapted to include this information.

As can be seen, the NCR table includes one column to store cell category information, which information may be used by the base station 6 for planning/prioritising handovers and cell reselection (e.g. to avoid intermittent cells when appropriate). In other words, using the cell category information, the base station 6 is able to prioritise conventional cells (non-NTN cells), when appropriate. However, for some UEs 3, NTN cells may be selected. In any case, the base station 6 can take into account the cell category of its neighbour cells in addition to the information normally used (e.g. signal measurement results).

The NCR table also includes a column to store appropriate cell timing information (if available) indicating a neighbour cell's availability. For an energy saving or small cell, the cell timing information may identify the period(s) during which the cell is on and off (a period during which the cell is operational and a period during which the cell is not operational). This information may also be used to assist the base station 6 in cell reselection/handover assistance to the UEs 3 in its own cell. This information may be used to activate/deactivate (enable/disable) certain neighbour cells in a predictable manner, based on their associated timing (without removing the corresponding neighbour relation data and without having to re-acquire the relevant neighbour cell information when the cell comes online again at a specified time, for a specified period).

Although not shown in FIG. 9, ephemeris information may also be stored for NTN cells (e.g. in the cell timing information column or in a separate column or field), from which the base station 6 can work out the availability of a given NTN cell in a given geographical area, for a specific time of the day. This information may be used in a similar manner as the above described cell timing information.

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms | | |
| UAS platform | 8-50 km | | of elevation/azimuth with | 5-200 | km |
| (including HAPS) | (20 km for HAPS) | | respect to a given earth point | | |
| High Elliptical Orbit | 400-50000 | km | Elliptical around the earth | 200-3500 | km |
| (HEO) satellite | | | | | |

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above described mobile device may comprise an MTC/IoT device and/or the like.

The cell category may indicate at least one of: a small cell; an energy saving cell; a cell for Ultra-Reliable Low-Latency Communication (URLLC); a cell of a terrestrial network; a cell of a non-terrestrial network; a Geostationary Earth Orbit (GEO) cell, a Non-Geostationary Earth Orbit (NGEO) cell; a Low Earth Orbit (LEO) cell, a Medium Earth Orbit (MEO) cell, a Highly Elliptical Orbit (HEO) cell; a High Altitude Platforms (HAPs) cell; a quasi-earth-fixed cell; and an earth-moving cell.

The method performed by the base station may further comprise at least one of: controlling handover towards the neighbour cell based on the received information; controlling cell reselection towards the neighbour cell based on the received information; and managing availability of the neighbour cell based on the received information.

The method performed by the base station may comprise receiving said information from a user equipment (UE) using an information element comprising measurement results relating to the neighbour cell (e.g. a MeasResultNR-CellInfo information element or a MeasResultNR-rel17 information element).

The method performed by the base station may further comprise transmitting a Radio Resource Control (RRC) message comprising at least one information element requesting the UE to report said information (e.g. a ReportCellCategoryInfo information element or a ReportCGIandCellCategoryInfo information element).

The method performed by the base station may comprise receiving said information from a base station operating the neighbour cell (e.g. via an Access and Mobility Function (AMF) or via an Xn interface).

The method performed by the base station may comprise receiving said information during Xn interface setup procedure with the base station operating the neighbour cell (e.g. in an XnSetupResponse message).

The method performed by the base station may comprise receiving said information using at least one of a Self-Organising Network (SON) Information Request procedure and a Radio Access Network (RAN) Configuration Transfer message).

The method performed by the base station may comprise receiving said information using at least one information element indicating a cell category associated with the neighbour cell (e.g. a CellCategory-Info information element).

The method performed by the AMF may comprise obtaining at least a part of said information from: a base station operating the cell (e.g. during NG setup and/or RAN Configuration update for said cell); an Operation and Maintenance (OAM) node; a user equipment (UE); and another AMF.

The received information may comprise information relating to an availability of said cell (e.g. ephemeris information when said neighbour cell is a cell of a non-terrestrial network, or information identifying at least one of a period during which the cell is operational and a period during which the cell is not operational when the neighbour cell is a cell of a non-terrestrial network, an energy saving cell, or a small cell).

The cell timing information stored in the neighbour cell relation table may comprise information identifying at least one of: a period during which a particular cell is operational and a period during which a particular cell is not operational.

Also disclosed is a method performed by a base station, the method comprising:
receiving at least one of: information indicating a cell category associated with a neighbour cell; information identifying a cell timing associated with the neighbour cell; and ephemeris information associated with the neighbour cell; and
updating neighbour cell information based on the received information.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by a base station, the method comprising:
receiving information relating to a cell category associated with a neighbour cell; and
updating neighbour cell information based on the information.

### (Supplementary Note 2)

The method according to Supplementary Note 1, wherein the cell category indicates at least one of:
a small cell;
an energy saving cell;
a cell for Ultra-Reliable Low-Latency Communication (URLLC);
a cell of a terrestrial network;
a cell of a non-terrestrial network;
a Geostationary Earth Orbit (GEO) cell;
a Non-Geostationary Earth Orbit (NGEO) cell;
a Low Earth Orbit (LEO) cell;
a Medium Earth Orbit (MEO) cell;
a Highly Elliptical Orbit (HEO) cell;
a High Altitude Platforms (HAPs) cell;
a quasi-earth-fixed cell; and
an earth-moving cell.

### (Supplementary Note 3)

The method according to Supplementary Note 1 or 2, further comprising at least one of:
controlling handover towards the neighbour cell based on the information;
controlling cell reselection towards the neighbour cell based on the information; and
managing availability of the neighbour cell based on the information.

### (Supplementary Note 4)

The method according to any of Supplementary Notes 1 to 3, wherein the receiving includes receiving the information, from a user equipment (UE), using an information element including measurement results relating to the neighbour cell.

### (Supplementary Note 5)

The method according to Supplementary Note 4, further comprising transmitting a Radio Resource Control (RRC) message including at least one information element requesting the UE to report the information.

### (Supplementary Note 6)

The method according to any of Supplementary Notes 1 to 5, wherein the receiving includes receiving the information from a base station operating the neighbour cell.

### (Supplementary Note 7)

The method according to Supplementary Note 6, wherein the receiving the information is performed during an inter-base station interface setup procedure with the base station operating the neighbour cell.

### (Supplementary Note 8)

The method according to Supplementary Note 6 or 7, wherein the receiving the information is performed using at least one of:
a Self-Organising Network (SON) Information Request procedure; and
a Radio Access Network (RAN) Configuration Transfer message.

### (Supplementary Note 9)

The method according to any of Supplementary Notes 1 to 8, wherein the receiving the information is performed using at least one information element indicating a cell category associated with the neighbour cell.

### (Supplementary Note 10)

The method according to any of Supplementary Notes 1 to 9, wherein the information includes information relating to an availability of the neighbour cell.

### (Supplementary Note 11)

A method performed by a core network node for mobility management, the method comprising:
obtaining information relating to a cell category associated with a cell; and
providing the information to a base station operating a neighbour cell.

### (Supplementary Note 12)

The method according to Supplementary Note 11, wherein the obtaining including obtaining at least a part of the information from one of: a base station operating the cell; an Operation and Maintenance (OAM) node; a user equipment (UE); and another core network node for mobility management.

### (Supplementary Note 13)

A method performed by a user equipment (UE), the method comprising:
obtaining information relating to a cell category associated with a neighbour cell; and
providing the information to a base station.

### (Supplementary Note 14)

A base station comprising:
means for receiving information relating to a cell category associated with a neighbour cell; and
means for updating neighbour cell information based on the information.

### (Supplementary Note 15)

A core network node for mobility management, comprising:
means for obtaining information relating to a cell category associated with a cell; and
means for providing the information to a base station operating a neighbour cell.

### (Supplementary Note 16)

A user equipment (UE) comprising:
means for obtaining information relating to a cell category associated with a neighbour cell; and
means for providing the information to a base station.

### (Supplementary Note 17)

A neighbour cell relation table configured to store at least one of:
information identifying a cell category associated with at least one cell;
ephemeris information for at least one cell; and
cell timing information for at least one cell.

### (Supplementary Note 18)

The neighbour cell relation table according to Supplementary Note 17, wherein the cell timing information includes information identifying at least one of:
a period during which a particular cell is operational; and
a period during which a particular cell is not operational.

This application is based upon and claims the benefit of priority from Great Britain Patent Application No. 2110490.6, filed on Jul. 21, 2021, the disclosure of which is incorporated herein in its entirety by reference.

### REFERENCE SIGNS LIST

1 Mobile telecommunication system
3 Mobile devices
5 Satellites
6 Base stations
7 Data network
9 Access and Mobility Management Function (AMF)
31 Transceiver circuit
33 Antenna
35 User interface
36 Universal Subscriber Identity Module (USIM)
37 Controller
39 Memory
41 Operating system
43 Communications control module
51 Transceiver circuit
53 Antenna
55 Network interface
57 Controller
59 Memory
61 Operating system
63 Communications control module
71 Transceiver circuit
75 Network interface
77 Controller
79 Memory
81 Operating system
83 Communications control module

What is claimed is:

1-18. (canceled)

19. A method performed by a base station, the method comprising:
receiving, from a core network node for mobility management, a Radio Access Network (RAN) configuration transfer message or a Self-Organizing Network (SON) information information element (IE) including information relating to a cell category associated with a neighbor cell; and
updating neighbor cell information based on the information.

20. The method according to claim 19, wherein
the information relating to the cell category is transmitted from a further base station operating the neighbor cell to the core network node, in a RAN configuration transfer message or a SON information IE.

21. The method according to claim 19, further comprising:
sending, to the core network node for mobility management, a RAN configuration transfer message or a SON information IE including information requesting the information relating the cell category.

22. The method according to claim 21, wherein
the information requesting the information relating to the cell category is transmitted from the core network node to a further base station operating the neighbor cell, in a RAN configuration transfer message or a SON information IE.

23. The method according to claim 19, further comprising at least one of:
controlling handover towards the neighbor cell based on the information;
controlling cell reselection towards the neighbor cell based on the information; and
managing availability of the neighbor cell based on the information.

24. The method according to claim 19, wherein the information includes information relating to an availability of the neighbor cell.

25. The method according to claim 19, wherein the cell category indicates at least one of:
a small cell;
an energy saving cell;
a cell for Ultra-Reliable Low-Latency Communication (URLLC);
a cell of a terrestrial network;
a cell of a non-terrestrial network;
a Geostationary Earth Orbit (GEO) cell;
a Non-Geostationary Earth Orbit (NGEO) cell;
a Low Earth Orbit (LEO) cell;
a Medium Earth Orbit (MEO) cell;
a Highly Elliptical Orbit (HEO) cell;
a High Altitude Platforms (HAPs) cell;
a quasi-earth-fixed cell; and
an earth-moving cell.

26. A method performed by a core network node for mobility management, the method comprising:
receiving, from a base station operating a cell, a Radio Access Network (RAN) configuration transfer message or a Self-Organizing Network (SON) information information element (IE) including information relating to a cell category associated with the cell; and
sending a RAN configuration transfer message or a SON information IE including the information to a further base station operating a neighbor cell.

27. A base station comprising:
a memory storing instructions; and
at least one processor configured to process the instructions to:
receive, from a core network node for mobility management, a Radio Access Network (RAN) configuration transfer message or a Self-Organizing Network (SON) information information element (IE) including information relating to a cell category associated with a neighbor cell; and
update neighbor cell information based on the information.

28. A core network node for mobility management comprising:
a memory storing instructions; and
at least one processor configured to process the instructions to:
receive, from a base station operating a cell, a Radio Access Network (RAN) configuration transfer message or a Self-Organizing Network (SON) information information element (IE) including information relating to a cell category associated with the cell; and
send a RAN configuration transfer message or a SON information IE including the information to a further base station operating a neighbor cell.
